(19) United States
(12) Patent Application Publication
(10) Pub. No.: US 2014/0166591 A1
(43) Pub. Date: Jun. 19, 2014

(54) PCO/UVC/CARBON WATER FILTER

(71) Applicant: Mohamed H. Tarifi, Hillsboro Beach, FL (US)

(72) Inventor: Mohamed H. Tarifi, Hillsboro Beach, FL (US)

(21) Appl. No.: 13/719,222

(22) Filed: Dec. 18, 2012

(51) Int. Cl. C02F 1/32

(52) U.S. Cl. CPC C02F 1/32
USPC 210/748.1; 210/251

(57) ABSTRACT

A water filter will sterilize and detoxify water by taking advantage of two technologies in the field of water disinfection and detoxification—ultraviolet “C” (UVC) and photocatalytic oxidation (PCO). The water filter includes a filter body that contains a water inlet, a flow header and granular activated carbon. A UVC lamp sleeve extends into the filter body into which a UVC lamp is disposed. The filter body, the UVC sleeve and the granulated activated carbon are coated with titanium dioxide, turning all these surfaces into a semi-conductor that triggers a powerful PCO process when UVC photons comes in contact therewith. The carbon media adsorbs organic compounds present in the incoming water, allowing the PCO and UVC ample time to complete the oxidation process. Continuous break down of organic compounds by PCO and UVC allows the carbon media to self-regenerate itself indefinitely. The technology is scalable to any size and application.

### BACKGROUND OF THE INVENTION

The present invention relates to water filters and, more particularly, to a water filter that can sterilize and detoxify water.

Current water filters employ granular activated carbon media in the form of a cartridge. The carbon media reduce taste and odor and absorb a percent of organic and inorganic compounds present in water

There are several limitations to such activated carbon water filtering cartridges. First, the life expectancy of the cartridges is limited, requiring replacement of the media and/or cartridge every three to six months. For example, some advanced refrigerators that dispense water or make ice have automatic indicators that tell the user when to replace their water filter cartridge.

Also, the media absorbs nutrients from the incoming source of drinking water. Due to the intermittent use of the activated carbon filter, the media becomes an optimum bacteria-growing field, which gets washed out with the next usage. The presence of nutrients absorbed by the carbon media coupled with room temperature provide optimum conditions for growing bacteria and mold. The user may believe they are getting purified water from passing it through the filter, however, they may also be getting bacteria that has grown and multiplied since the last time water flowed through the filter.

In addition, there are many situations where the filter user does not know when to replace the carbon cartridge or just forgets. As the media becomes exhausted and experiences a breakthrough, the absorbed organic compounds, along with accumulated bacteria, begin to leach out of the cartridge at each use. Many worst conditions occur when users go on vacation whether brief or extended.

As can be seen, there is a need for an improved water filtration system that has a long life span and can provide a continuous supply of purified water.

### SUMMARY OF THE INVENTION

In one aspect of the present invention, a water filtration system comprises a water inlet into a filter body; a water outlet from the filter body; a quartz sleeve extending into an interior of the filter body; an ultraviolet lamp disposed in the quartz sleeve; granular activated carbon disposed in the filter body; and titanium dioxide applied to the quartz sleeve, the inside walls filter body and to the granular activated carbon.

In another aspect of the present invention, a water filtration system comprises a water inlet into a filter body; a water outlet from the filter body; a quartz sleeve extending into an interior of the filter body; an ultraviolet lamp disposed in the quartz sleeve; granular activated carbon disposed in the filter body; titanium dioxide applied in Nano layers to the outside wall of the quartz sleeve, the inside walls of the filter body and to the granular activated carbon; a rechargeable battery disposed in a filter body enclosure, the rechargeable battery operable to power the ultraviolet lamp; on/off switch disposed on an exterior of the water filtration system; and a direct current jack socket for supplying power to the rechargeable battery.

In a further aspect of the present invention, a method for purifying water comprises turning on a UV lamp of a water filtration system, the water filtration system including a water inlet allowing water to pass into a filter body, a water outlet allowing water to pass out from the filter body, a quartz sleeve extending into an interior of the filter body and housing the UV lamp, granulated activated carbon disposed in the filter body, and titanium dioxide applied to the quartz sleeve, the inside walls of the filter body and to the granulated activated carbon; waiting a period of time before turning on water flow to sterilize impurities in the water filtration system; and passing water through the water filtration system.

These and other features, aspects and advantages of the present invention will become better understood with reference to the following drawings, description and claims.

### BRIEF DESCRIPTION OF THE DRAWINGS

FIG. 1 is a cross-sectional view of a water purification apparatus according to an exemplary embodiment of the present invention;

FIG. 2 is an end view of the water purification apparatus of FIG. 1;

FIG. 3 is an exploded perspective view of the water purification apparatus of FIG. 1;

FIG. 4 is a cross-sectional view of a water purification apparatus according to an alternate embodiment of the present invention;

FIG. 5 is a graph showing the UV intensity at 3.6 V DC input over time for the UV lamp of the water purification apparatus of FIG. 1; and

FIG. 6 is a graph showing temperature rise of a power transformer and a UV lamp of the water purification apparatus of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a water filter that will sterilize and detoxify water by taking advantage of two technologies in the field of water disinfection and detoxification—ultraviolet “C” (UVC) and photocatalytic oxidation (PCO). The water filter includes a filter body that contains a water inlet, a flow header and granulated activated carbon. A UVC lamp sleeve extends into the filter body into which a UVC lamp is disposed. One or more of the filter body, the UVC sleeve and the granular activated carbon can be coated with titanium dioxide.

Referring to FIG. 1, a water filter 10 can include a filter body 12 and a filter body enclosure 14. The filter body 12 can include a water inlet 16 operable to connect to a water source (not shown), such as a water faucet. The water inlet 16 can pass through a hole 18 in the filter body 12 and o-rings 20 can create a seal to prevent leakage of water through the hole 18 when the water inlet 16 is disposed therein. In an alternative embodiment, the water inlet 16 can be formed integrally into the filter body 12.

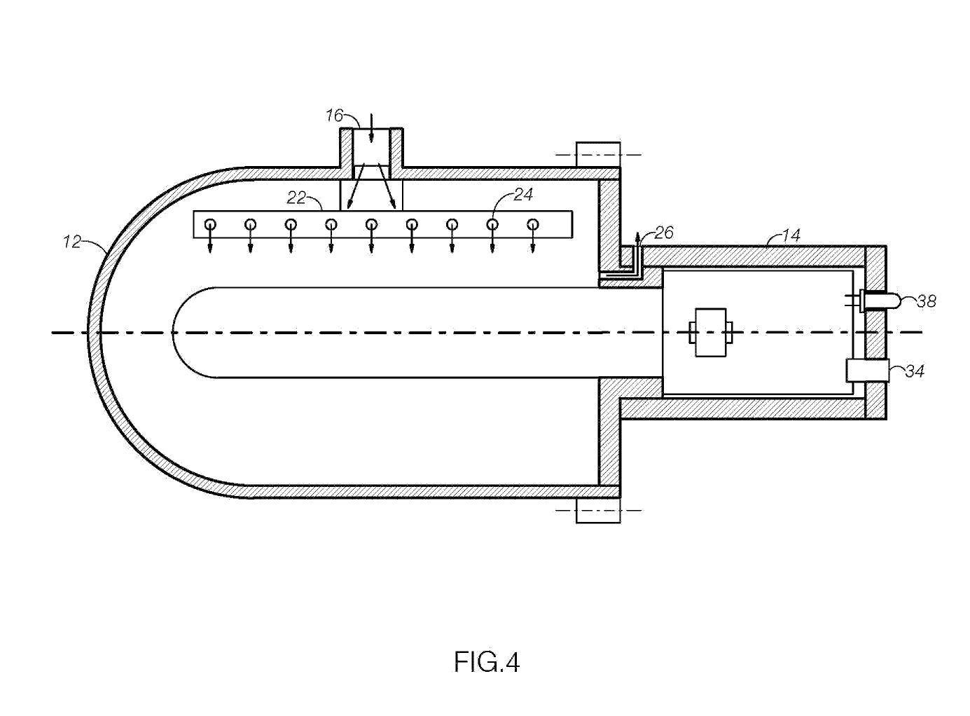

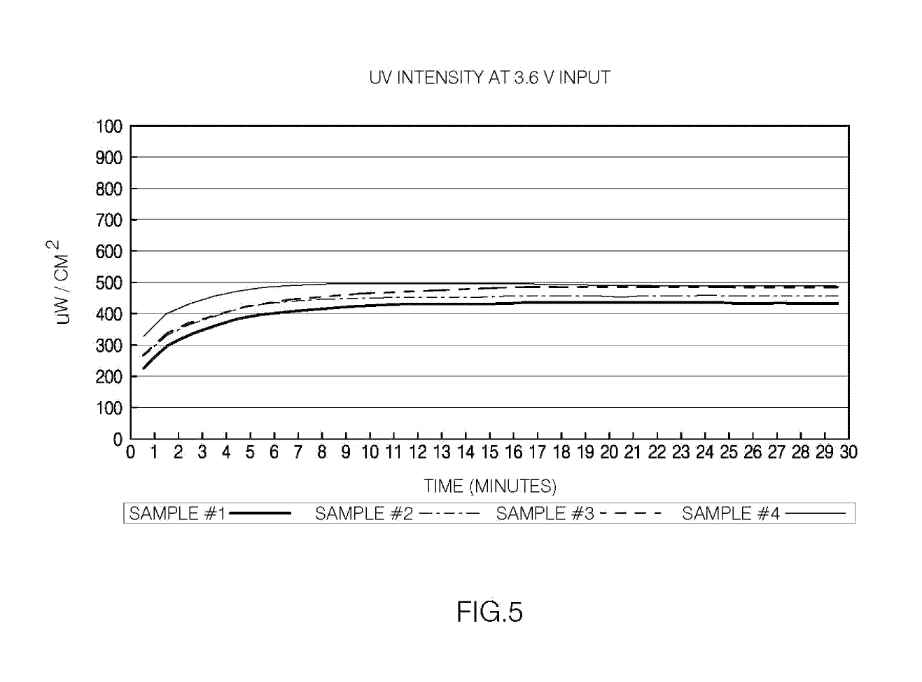

The water inlet 16 can include a flow header 22 for delivering water flow out of the water inlet 16 and into the filter body 12. The flow manifold 22 can include a plurality of nozzles 24 (see FIG. 4). Typically, the nozzles 24 are disposed in two rows and are staggered.

Granular activated carbon 42 (only partially shown, not to scale, in FIG. 1) can be placed inside the filter body 12. The granular activated carbon 42 can provide a substrate for the absorption of impurities from the water prior to ultraviolet-C (UVC) and photocatalytic oxidation (PCO) destruction of those impurities, as described below.

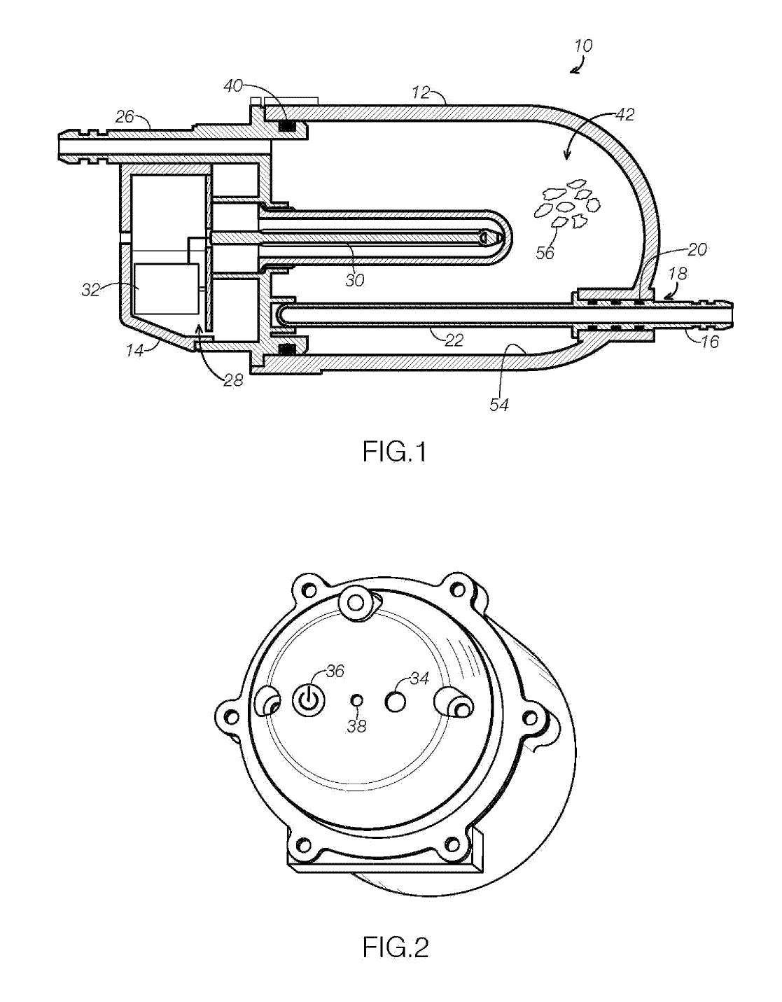

The filter body enclosure 14 can include a water outlet 26 and a control board 28 having a UV lamp 30 and a ballast. A battery pack 32 can be provided within the filter body enclosure 14. The battery pack 32 can be charged by providing power through a DC jack socket 34 (see FIG. 2). The water filter 10 can be powered by either the battery pack 32 or via power supplied into the DC jack socket 34. As shown in FIG. 2, a switch 36 can be provided for turning the the UVC lamp 30 on and off and an indicator 38, such as an LED, can be viewable by a user to determine whether the UVC lamp is powered on or off.

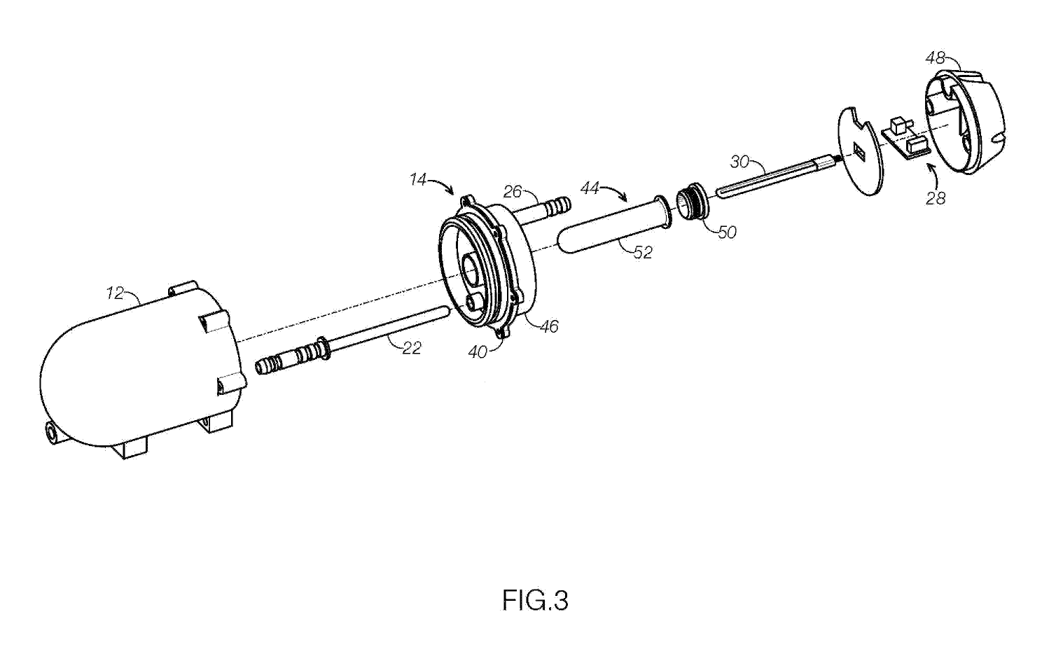

As shown in FIG. 3, the filter body enclosure 14 can be made as two components, a sealing member 46 that forms a seal with the filter body 12, and a top cap 48 that houses the electrical components (such as control board 28).

The filter body enclosure 14 can attach to the filter body 12 by various means. For example, the filter body enclosure 14 can thread onto the filter body 12, snap on the filter body 12, twist-lock on the filter body 12, or the like. An o-ring 40 can be used to provide a seal between the filter body enclosure 14 and the filter body 12.

The UV lamp 30 can be encased in a quartz tube 44. A gasket member 50 (FIG. 3) can be used to prevent water from entering the quartz tube 44. Various designs for the gasket member 50 and quartz tube 44 may be used within the scope of the present invention.

The quartz tube 44 may be coated with nano layer of titanium dioxide (TiO₂) coating 52. In addition, the inside wall surface of the filter body 12 can be coated with body titanium dioxide coating 54, as shown in FIG. 1. Moreover, the granular activated carbon 42 can be coated with an activated carbon titanium dioxide coating 56. The titanium dioxide coatings 52, 54, 56 turns all coated surfaces into a semiconductor that triggers a photo catalytic oxidation process when the semiconductor is bombarded by ultra violet C photons emitted from the UVC lamp. The PCO process combined with the UVC photons would sterilize the water and breakdown any organic compound present in the incoming water to carbon dioxide and water. The carbon media allows ample time for the PCO Process to complete the oxidation process resulting in final oxidation byproduct of carbon dioxide and water. The continuous breakdown of organic compounds by the PCO and UVC allows the carbon media to self regenerate itself indefinitely precluding the need for media replacement. The UVC lamp 30 of the present invention can be turned on just prior to water flow, typically about five seconds before opening the water faucet, allowing UVC and the PCO process to sterilize any bacteria that may have been formed since last use. As discussed above, conventional water filters can allow bacteria to build up between uses, flushing that active bacteria out when the water flow starts. With the water filter of the present invention, a user can turn on the filter just prior to using the water to destroy bacteria that may have developed between uses. Additionally, with conventional filters, the activated carbon becomes “clogged” with contaminants and is no longer effective as a filtering agent.

The only maintenance needed with the system of the present invention is charging the battery pack and replacing the UV lamp, which typically can last for about two years of use or more.

The titanium dioxide turns the inside filter walls, outside surface of the quartz sleeve and the granular activated carbon into semi-conductors. PCO is activated as soon as UVC photos come in contact with any semi-conductor surface. The hydroxyl radicals formed by the PCO process destroys organisms on contact and breaks down any organic compounds absorbed by the granulator activated carbon. In concert with the PCO, the UVC also kills off organisms on contact and breaks down organic compounds.

FIG. 4 shows an alternate embodiment of a water purification device, having a slightly differently positioned inlet and outlet. Depending on the application and end user needs, the inlet and outlet may be positioned as necessary without taking away from the function of the present invention.

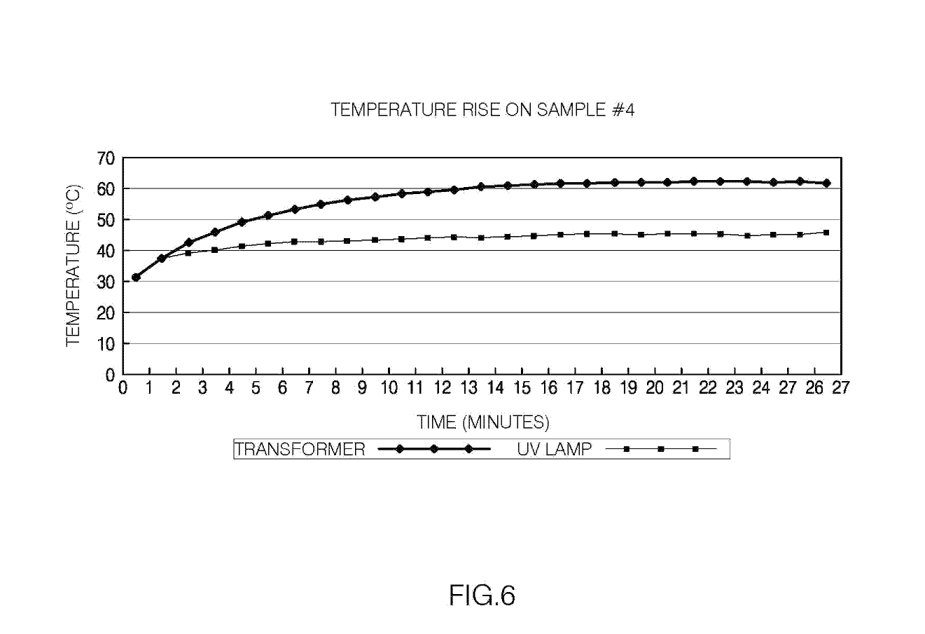

FIG. 5 shows UV intensity of four sample lamps at 3.6V DC input. Each lamp may ramp up over the first 7-10 minutes of use to reach a steady state output from about 420 uW/cm² to about 500 uW/cm² (measured about 20 mm from the UV lamp). FIG. 6 shows the temperature rise on sample 4 from FIG. 5. The temperature rise of the transformer was from ambient to about 60° C. and the temperature rise of the UV lamp was from ambient to about 45° C.

The system of the present invention can be deployed and scaled in various applications. For example, the system can be directly connected to bathroom or kitchen sink faucet. A scaled up system can be housed under a kitchen sink that may supply filtered water for a whole house needs. In addition, the system can be scaled up to be a unit process for polishing water in a water treatment plant.

It should be understood, of course, that the foregoing relates to exemplary embodiments of the invention and that modifications may be made without departing from the spirit and scope of the invention as set forth in the following claims.

1. A water filtration system comprising:
a water inlet into a filter body;
a water outlet from the filter body;
a quartz sleeve extending into an interior of the filter body;
an ultraviolet lamp disposed in the quartz sleeve;
granular activated carbon media disposed in the filter body; and
titanium dioxide applied to the quartz sleeve, inside walls of the filter body and to the granular activated carbon media, wherein
ultraviolet c photons emitted by the ultraviolet lamp reach the titanium dioxide applied to the granular activated carbon media, the quartz sleeve and the inside walls of the filter body to trigger a photo catalytic oxidation reaction, and
the photo catalytic oxidation reaction destroys organisms on contact and breaks down any organic compounds absorbed by the granular activated carbon.

2. The water filtration system of claim 1, further comprising a control board, lamp ballast and a chargeable battery located in a filter body enclosure.

3. The water filtration system of claim 1, further comprising a rechargeable battery disposed in a filter body enclosure, the rechargeable battery operable to power the ultraviolet lamp.

4. The water filtration system of claim 1, further comprising an on/off switch disposed on an exterior of the water filtration system.

5. The water filtration system of claim 3, further comprising a direct current jack socket for supplying power to the rechargeable battery.

6. The water filtration system of claim 1, further comprising an indicator lamp on an exterior of the water filtration system, the indicator lamp operable to illuminate when the ultraviolet lamp is illuminated.

7. The water filtration system of claim 1, further comprising nozzles in a water manifold communicating with the water inlet, the nozzles directing water in a direction around the quartz sleeve and the inside walls of the filter.

8. The water filtration system of claim 7, wherein the water manifold comprise two rows of staggered nozzles.

9. A water filtration system comprising:
a water inlet into a filter body;
a water outlet from the filter body;
a quartz sleeve extending into an interior of the filter body;
an ultraviolet lamp disposed in the quartz sleeve;
granular activated carbon disposed in the filter body;
titanium dioxide applied to the quartz sleeve, a inside walls of the filter body and to the granulated activated carbon;
a rechargeable battery disposed in a filter body enclosure, the rechargeable battery operable to power the ultraviolet lamp;
on/off switch disposed on an exterior of the water filtration system; and
a direct current jack socket for supplying power to the rechargeable battery, wherein
ultraviolet c photons emitted by the ultraviolet lamp reach the titanium dioxide applied to the granular activated carbon media, the Quartz sleeve and the inside walls of the filter body and trigger a photo catalytic oxidation reaction, and
the photo catalytic oxidation reaction destroys organisms on contact and breaks down any organic compounds absorbed by the granular activated carbon.

10. The water filtration system of claim 9, further comprising a control board and lamp ballast located in a filter body enclosure.

11. The water filtration system of claim 9, further comprising an indicator lamp on an exterior of the water filtration system, the indicator lamp operable to illuminate when the ultraviolet lamp is turned on.

12. The water filtration system of claim 9, is further comprising nozzles in a water manifold, the nozzles directing water around the quartz sleeve and the filter walls creating a circular pattern that disperses the granular activated carbon and allows UVC photons easy access to all parts of a semi-conductor formed from the UVC and titanium dioxide.

13. The water filtration system of claim 12, wherein the header has two rows of staggered nozzles.

14. A method for purifying water comprising:
turning on a UV lamp of a water filtration system, the water filtration system including a water inlet allowing water to pass into a filter body, a water outlet allowing water to pass out from the filter body, a quartz sleeve extending into an interior of the filter body and housing the UV lamp, granular activated carbon media disposed in the filter body, and titanium dioxide applied to the quartz sleeve, inside walls of the filter body and to the granular activated carbon, wherein ultraviolet c photons emitted by the ultraviolet lamp reach the titanium dioxide applied to the granular activated carbon media, the quartz sleeve and the inside walls of the filter body and trigger a photo catalytic oxidation reaction, and the photo catalytic oxidation reaction destroys organisms on contact and breaks down any organic compounds absorbed by the granular activated carbon;
waiting about five seconds before turning on water flow to allow UVC/PCO to sterilize left over water from previous use of the water filtration system.

15. The method of claim 14, further comprising powering the UV lamp with a rechargeable battery.

16. The method of claim 14, further comprising directing water through the water inlet and toward the UV lamp via a plurality of nozzles in a water manifold.

17. The method of claim 14, wherein photocatalytic oxidation (PCO) and UV photons and TiO₂ coated granular activated carbon work in synergy to sterilize water and breakdown organic compounds to carbon dioxide and water.

18. The method of claim 14, further comprising continually breaking down organic compounds absorbed by the granular activated carbon media to allow the media to continuously regenerate itself.

19. The method of claim 14, further comprising absorbing toxic organic compounds on the granulated activated carbon media for a sufficient period of time to permit complete breakdown to carbon dioxide and water.
